(19) United States
(12) Patent Application Publication
(10) Pub. No.: US 2022/0303011 A1
(43) Pub. Date: Sep. 22, 2022

(54) TRANSMITTER, RECEIVER, AND COMMUNICATION SYSTEM

(71) Applicant: FUJIKURA LTD., Tokyo (JP)

(72) Inventor: Yoshinori Arai, Chiba (JP)

(73) Assignee: FUJIKURA LTD., Tokyo (JP)

(21) Appl. No.: 17/635,469

(22) PCT Filed: Aug. 31, 2020
(86) PCT No.: PCT/JP2020/032955

§ 371 Date: Feb. 15, 2022

(30) Foreign Application Priority Data
Aug. 29, 2019 (JP) 2019-157441

(51) Int. Cl. H04B 10/25; G02B 6/42; H04B 10/69; H04B 10/50

(52) U.S. Cl. CPC H04B 10/25; G02B 6/4292; H04B 10/69; H04B 10/50

(57) ABSTRACT

A transmitter includes: a first substrate; a signal source disposed on the first substrate; a second substrate different from the first substrate; an electrical-to-optical (E/O) converter disposed on the second substrate and that converts an electrical signal outputted from the signal source into an optical signal; an optical cable that carries the optical signal; and an optical connector disposed at an end of the optical cable. The electrical signal is inputted into the E/O converter.

### TECHNICAL FIELD

The present invention relates to a transmitter for transmitting an optical signal, a receiver for receiving the optical signal, and a communication system for transmitting and receiving the optical signal.

### BACKGROUND

Inter-device communications have conventionally been conducted by using a metal cable as a transmission medium to transmit and receive electrical signals. A universal serial bus (USB) cable and a high-definition digital media interface (HDMI) (registered trademark) cable are typical examples of the metal cable that is used in the inter-device communications.

However, it is difficult to increase a transmission distance and a transmission rate in the inter-device communications using a metal cable. As a solution to this problem, an active optical cable (AOC) has recently been receiving attention as a transmission medium which replaces the metal cable. The AOC is composed of (1) an optical cable, (2) a first connector which is provided at one end of the optical cable and which incorporates an electrical-to-optical (E/O) converter, and (3) a second connector which is provided at the other end of the optical cable and which incorporates an optical-to-electrical (O/E) converter. An electrical signal outputted from a transmitting-side device (for example, a camera) is converted, by the E/O converter of the first connector that is connected to the transmitting-side device, into an optical signal, which is then transmitted through the optical cable. The optical signal having been transmitted through the optical cable is converted, by the O/E converter of the second connector that is connected to a receiving-side device (for example, a grabber), into an electrical signal, which is then inputted to the receiving-side device. The AOC is disclosed in, for example, Patent Literature 1.

### PATENT LITERATURE

Patent Literature 1

Japanese Patent Application Publication Tokukai No. 2012-60522

In the inter-device communications using an AOC, electrical signals such as USB signals and HDMI signals, which are compliant with general-purpose communications standards, are converted into optical signals. Therefore, the transmitting-side device needs to include a communications interface for converting an original signal (an electrical signal outputted by a signal source) into an electrical signal that is compliant with a general-purpose communications standard. In addition, the receiving-side device needs to include a communications interface for extracting the original signal from the electrical signal that is compliant with the general-purpose communications standard. This makes it difficult to make more compact or simpler both the transmitting-side device and the receiving-side device.

One or more embodiments of the invention provide a transmitter that is easy to make more compact or simpler, provide a receiver that is easy to make more compact or simpler, or provide a communication system in which a transmitter and a receiver are easy to make more compact or simpler.

### SUMMARY

A transmitter in accordance with one or more embodiments of the present invention includes a configuration in which the transmitter includes: a first substrate; a signal source provided to the first substrate; a second substrate different from the first substrate; an E/O converter provided to the second substrate and configured to convert, into an optical signal, an electrical signal outputted from the signal source; an optical cable that carries the optical signal outputted from the E/O converter; and an optical connector provided at an end of the optical cable, the electrical signal outputted from the signal source being inputted as is into the E/O converter.

A receiver in accordance with one or more embodiments of the present invention that is configured to receive an optical signal transmitted from the transmitter in accordance with one or more embodiments of the present invention includes a configuration in which the receiver includes: an O/E converter configured to convert the optical signal into an electrical signal; and a receiver circuit configured to process, as an electrical signal outputted from the signal source, the electrical signal outputted from the O/E converter.

A communication system in accordance with one or more embodiments of the present invention includes a configuration in which the communication system includes a transmitter in accordance with one or more embodiments of the present invention; and a receiver in accordance with one or more embodiments of the present invention.

One or more embodiments of the present invention makes it possible to provide a transmitter that is easy to make more compact or simpler, to provide a receiver that is easy to make more compact or simpler, and to provide a communication system in which a transmitter and a receiver are easy to make more compact or simpler.

### BRIEF DESCRIPTION OF THE DRAWINGS

FIG. 1 is a block diagram illustrating a configuration of a communication system in accordance with one or more embodiments of the present invention.

(a) of FIG. 2 is a side view illustrating the configuration of the transmitter illustrated in FIG. 1; (b) of FIG. 2 is a plan view of a first substrate included in the transmitter illustrated in (a) of FIG. 2; and (c) of FIG. 2 is a plan view of a second substrate included in the transmitter illustrated in (a) of FIG. 2.

FIG. 3 is a block diagram illustrating Variation 1 of the transmitter illustrated in FIG. 1.

FIG. 4 is a block diagram illustrating Variation 2 of the transmitter illustrated in FIG. 1.

FIG. 5 is a block diagram illustrating Variation 3 of the transmitter illustrated in FIG. 1.

FIG. 6 is a block diagram illustrating Variation 4 of the transmitter illustrated in FIG. 1.

FIG. 7 is a plan view illustrating Variation 5 of the transmitter illustrated in FIG. 1.

FIG. 8 is a plan view illustrating Variation 6 of the transmitter illustrated in FIG. 1.

FIG. 9 is a plan view illustrating Variation 7 of the transmitter illustrated in FIG. 1.

### DETAILED DESCRIPTION

(Configuration of Communication System)

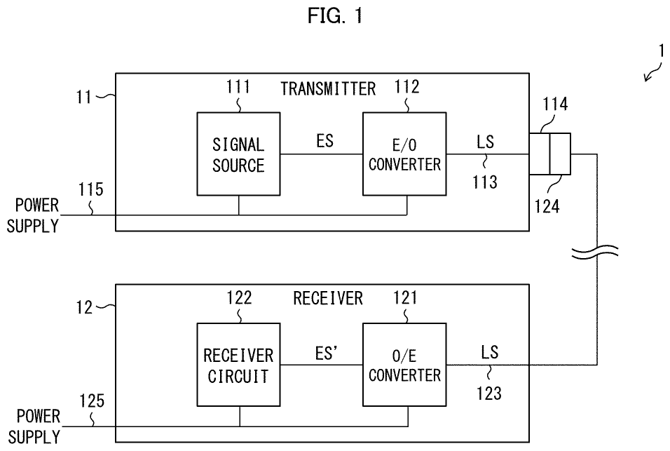

The following description will discuss a configuration of a communication system 1 in accordance with one or more embodiments of the present invention, with reference to FIG. 1. FIG. 1 is a block diagram illustrating a configuration of the communication system 1.

As illustrated in FIG. 1, the communication system 1 includes: a transmitter 11 that transmits an optical signal LS; and a receiver 12 that receives the optical signal LS.

The transmitter 11 includes: a signal source 111 that outputs an electrical signal ES; an E/O converter 112 that converts the electrical signal ES into an optical signal LS; an optical cable 113 that carries the optical signal LS outputted from the E/O converter 112. The receiver 12 includes an O/E converter 121 that converts the optical signal LS into an electrical signal ES'; a receiver circuit 122 that processes, as the electrical signal ES outputted from the signal source 111, the electrical signal ES′ outputted from the O/E converter 121; and an optical cable 123 that carries the optical signal LS to be inputted to the O/E converter 121. This configuration makes it possible to provide the communication system 1, the transmitter 11, and the receiver 12 that are capable of transmitting, over a long distance and at a high rate, the electrical signal ES outputted from the signal source 111. In other words, this configuration makes it possible to yield an effect similar to that yielded by monitoring, in real time in a device that is apart from the signal source 111 and that is electrically connected to the receiver 12, the electrical signal ES outputted from the signal source 111. Further, the electrical signal ES outputted from the signal source 111 is inputted to the E/O converter 112 without the intervention of a general-purpose communications interface (such as a USB interface and an HDMI). This eliminates the provision of a general-purpose communications interface in the transmitter 11 and/or the receiver 12. It is therefore easy to make the transmitter 11 and/or the receiver 12 more compact or simpler.

In one or more embodiments, the signal source 111 is an image sensor and the electrical signal ES is an image signal outputted from the image sensor. In one or more embodiments, the receiver circuit 122 processes, as the image signal outputted from the image sensor, the electrical signal ES′ outputted from the O/E converter 121. It is therefore possible to provide the communication system 1, the transmitter 11, and the receiver 12 that are capable of transmitting, over a long distance and at a high rate, the electrical signal outputted from the image sensor. In other words, it is possible to monitor, in real time at a location that is apart from the image sensor and that is near or in the receiver 12, the image signal outputted from the image sensor.

Examples of the image signal outputted from the image sensor include an image signal compliant with a scalable low voltage signaling embedded clock (SLVS-EC) or a mobile industry processor interface (MIPI) (registered trademark). It should be noted that the SLVS-EC and the MIPI are communications standards used exclusively for image transmission and are not general-purpose communications standards such as a USB and an HDMI. The image signal compliant with the SLVS-EC contains a clock in a data column thereof and is therefore advantageously free of skews (variations in delay time). Further, the image signal compliant with the SLVS-EC has a good DC balance and, therefore, may be used to establish optical communications between devices. The MIPI is a common standard. When the image signal is compliant with the MIPI, it is possible to connect the transmitter 11 to many kinds of devices compliant with the MIPI and to connect the many kinds of devices compliant with the MIPI to the receiver 12 (which will be described later). Therefore, the image signal compliant with the MIPI may be used for inter-device communications between the many kinds of devices.

In one or more embodiments, the transmitter 11 further includes an optical connector 114 provided at an end of the optical cable 113. The optical cable 113 can therefore be understood as an optical cable that connects the E/O converter 112 and the optical connector 114. The transmitter 11 may further include a housing for housing at least the signal source 111 and the E/O converter 112. The optical connector 114 may be provided at an end part of the housing of the transmitter 11, or may be provided to be apart from the end part of the housing of the transmitter 11. In one or more embodiments, the receiver 12 further includes an optical connector 124 provided at an end of the optical cable 123. The optical cable 123 can therefore be understood as an optical cable that connects the O/E converter 121 and the optical connector 124. The receiver 12 may further include a housing for housing at least the receiver circuit 122 and the O/E converter 121. The optical cable 123 is drawn from an end part of the housing of the receiver 12 and extends outside the receiver 12. The optical connector 124 may be provided at the end part of the housing of the receiver 12, or may be provided to be apart from the end part of the housing of the receiver 12. When the optical connectors 114 and 124 are connected to each other, the E/O converter 112 of the transmitter 11 is optically coupled to the O/E converter 121 of the receiver 12. The optical connector 114 and the optical connector 124 are removable connectors. This makes it possible to, when a failure occurs in the transmitter 11 (including the optical cable 113) of the communication system 1, replace the transmitter 11 without making a change to the receiver 12 (including the optical cable 123). Similarly, when a failure occurs in the receiver 12 (including the optical cable 123) of the communication system 1, it is possible to replace the receiver 12 without making a change to the transmitter 11 (including the optical cable 113). It is therefore easy, in the communication system 1, to address a failure that occurs in the transmitter 11 and/or the receiver 12. In the communication system 1, the optical cable 113 or the optical cable 123 is supposed to be used while being kept fixed. Examples of an aspect of the fixation of the optical cable 113 and the optical cable 123 include burying the optical cable 113 and the optical cable 123 in the ground. In the communication system, when a failure occurs in the transmitter 11 or the optical cable 113 while the optical cable 113 or the optical cable 123 are kept fixed, it is possible to replace the transmitter 11 without making a significant change to the receiver 12 or the optical cable 123. Further, the communication system 1, which includes the signal source 111 which is an image sensor, may be regarded as an aspect of an imaging system. Such an imaging system has performance that depends mainly on the signal source 111 included in the transmitter 11. When a user wishes to, for example, upgrade the signal source 111 in terms of resolution, or replace the signal source 111 with an infrared image sensor, it is possible, in the communication system 1, to upgrade or replace the transmitter 11 without making a significant change to the receiver 12 or the optical cable 123. Further, in a case where the signal source 111 is used as, for example, an image sensor of a monitoring camera, the receiver 12 is often disposed at a place that escapes observation (for example, an indoor location such as a monitoring room or a control room), whereas the transmitter 11 is often disposed at a place that comes under observation (an outdoor location in which there is the movement of people and vehicles). The transmitter 11 is therefore more likely to frequently break down than the receiver 12 is. For the above reasons, the communication system 1, in which it is possible to replace the transmitter 11 without making a significant change to the receiver 12 or the optical cable 123, is a rational communication system. Even when a failure occurs in the receiver 12 or the optical cable 123 while the optical cable 113 or the optical cable 123 is kept fixed, it is possible, in the communication system 1, to replace the receiver 12 without making a significant change to the transmitter 11 or the optical cable 113. In this context, when the transmitter 11 includes the above-described housing having an end part at which the optical connector 114 is provided, the optical cable 113 is housed in the optical connector 114 and the housing. This makes it possible to reduce or prevent failure occurrences in the optical cable 113 that are caused by external force or the like. Further, when the receiver 12 includes the above-described housing having an end part at which the optical connector 124 is provided, the optical cable 123 is housed in the optical connector 124 and the housing. This makes it possible to reduce or prevent failure occurrences in the optical cable 123 that are caused by external force or the like.

In an aspect of the communication system 1, the optical connector 114 and the optical connector 124 may be indirectly connected to each other by using an optical cable that is separate from the optical cable 113 and the optical cable 123. Alternatively, the optical connector 114 and the optical connector 124 may be directly connected to each other. Even when a failure occurs in the transmitter 11 and/or the receiver 12 while the optical cable connecting the optical connector 114 to the optical connector 124 is kept fixed, the former configuration in particular makes it possible to easily replace the faulty device.

General-purpose communications interfaces tend to generate heat while operating. The transmitter and/or the receiver that are/is provided with a general-purpose communications interface are/is therefore likely to become relatively large in size in consideration of the heat generated by the general-purpose communications interface. Accordingly, it is difficult to make the transmitter and/or the receiver compact. Conversely, the transmitter 11 and/or the receiver 12 do not need to be provided with a general-purpose communications interface, as described above. This eliminates the need to consider the heat generated by the general-purpose communications interface, and thereby makes it possible to make the transmitter 11 and/or the receiver 12 more compact.

In a case where the signal source 111 outputs n electrical signals as the electrical signal ES, the E/O converter 112 outputs n optical signals as the optical signal LS (n is any natural number that is not less than one). In this case, for example, an optical cable having n cores is used as the optical cables 113 and 123. Also in this case, a multi-fiber push on (MPO) connector having n or more cores is used as the optical connectors 114 and 124. The number of the cores of the MPO is not limited but may be selected as appropriate. The common number of the cores of the MPO includes 12 and 24.

In one or more embodiments, the transmitter 11 further includes a metal cable 115 that carries electric power to be supplied to at least the signal source 111 and which is independent of the optical cable 113. This enables, in the communication system 1, supply of electric power to the signal source 111 from a power supply disposed near or in the transmitter 11. This power supply is an example of a transmitting-side power supply and is for supplying electric power to the signal source 111. According to an aspect of the present invention, the metal cable 115 may be configured to supply electric power only to the signal source 111, may be configured to supply electric power to the signal source 111 and to the E/O converter 112, or may be configured to supply electric power only to the E/O converter 112. Accordingly, the metal cable 115 may be electrically connected only to the signal source 111, may be electrically connected to the signal source 111 and to the E/O converter 112, or may be electrically connected only to the E/O converter 112. In one or more embodiments, the electric power having been transmitted through the metal cable 115 is supplied to the E/O converter 112 as well as the signal source 111. This configuration eliminates the need to so provide a metal cable carrying electric power to the signal source 111 and the E/O converter 112 that the metal cable runs parallel to the optical cable 113. In other words, it is not necessary to use, as a cable to be connected to the E/O converter 112, a composite cable including an optical cable and a metal cable. The above configuration therefore makes it possible to make simpler the structure of the cable to be connected to the E/O converter 112 than a configuration in which a composite cable is used as the cable to be connected to the E/O converter 112. This enables a cost reduction. In addition, it can be possible to increase a transmission distance in the communication system 1. Furthermore, it can be possible to make the cable more compact and/or lighter. Provision of the cable in the form of an optical cable can enable a reduction in or prevention of a drop in voltage. Note that, in a case where the transmitter 11 includes a control section such as a microcomputer, electric power having been transmitted through the metal cable 115 may be supplied to this control section. Although the metal cable 115 and the E/O converter 112 are electrically connected to each other in one or more embodiments, the metal cable 115 and the E/O converter 112 may not be electrically connected to each other.

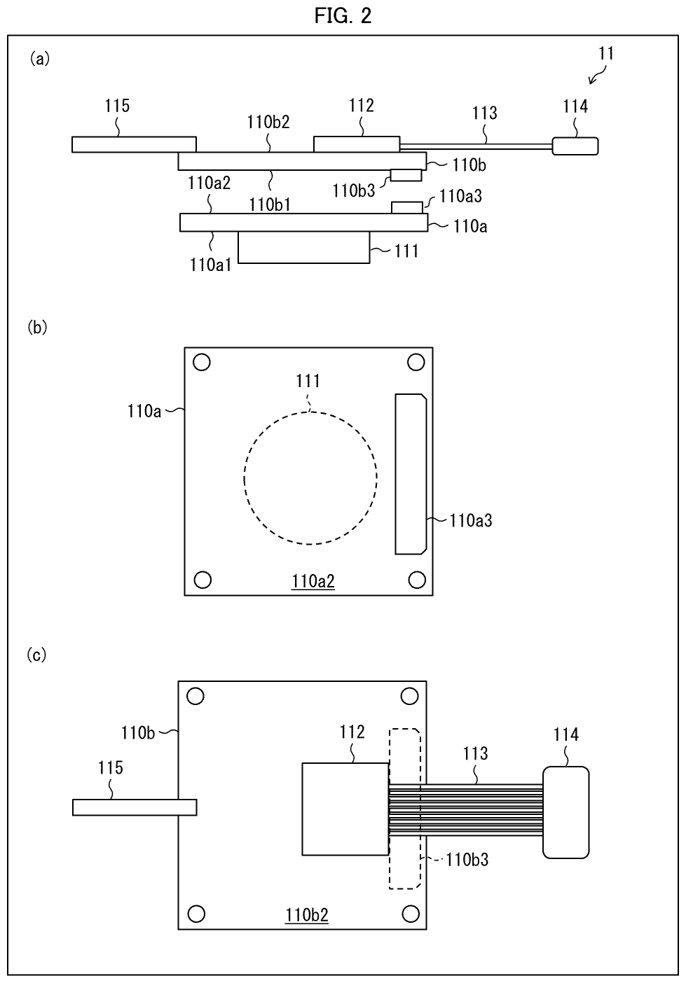

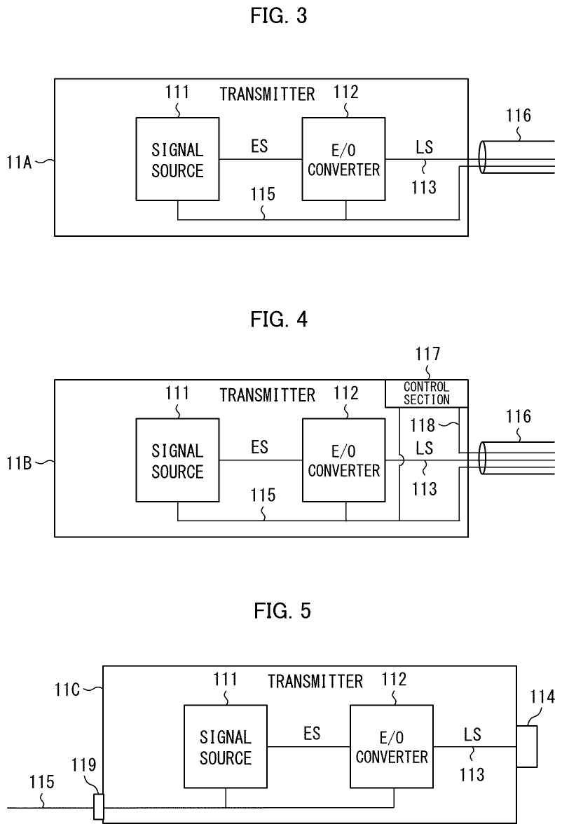

In one or more embodiments, the metal cable 115 has one end that is electrically connected to the signal source 111 and to the E/O converter 112. The metal cable 115 is an example of a metal cable for connecting a transmitting-side power supply, the metal cable being connectable to the transmitting-side power supply when the transmitting-side power supply is disposed outside the transmitter 11 and being capable of supplying electric power from the transmitting-side power supply to the signal source 111 and the E/O converter 112. The metal cable 115 is drawn from the housing of the transmitter 11 so as to be connectable to the transmitting-side power supply. This enables wiring of the metal cable 115 that is carried out independently of the optical cable 113 and the optical cable 123. It is therefore possible to determine a wiring route of the metal cable 115 independently of the wiring routes of the optical cable 113 and the optical cable 123. This eliminates the need to supply electric power from the receiver 12 to the signal source 111 and the E/O converter 112 of the transmitter 11, and therefore eliminates the need to use, as in Variation 1 (see FIG. 3), a composite cable 116 that includes the optical cable 113 and the metal cable 115. Accordingly, in a case where the transmitter 11 is connected to the receiver 12 by using a cable, one or more embodiments enable a reduction in the outer diameter of the cable in comparison with Variation 1.

In one or more embodiments, the receiver 12 includes a metal cable 125 that carries electric power to be supplied to the receiver circuit 122. This enables, in the communication system 1, supply of electric power from a power supply disposed near the receiver 12 to the receiver circuit 122. In one or more embodiments, the electric power having been transmitted through the metal cable 125 is supplied to the O/E converter 121 as well as the receiver circuit 122. In a case where the receiver 12 includes a control section such as a microcomputer, the electric power having been transmitted through the metal cable 125 may be supplied to this control section. Although the metal cable 125 and the O/E converter 121 is electrically connected to each other in one or more embodiments, the metal cable 125 and the O/E converter 121 may not be electrically connected to each other.

In one or more embodiments, the metal cable 125 has one end that is electrically connected to the O/E converter 121 and to the receiver circuit 122. The metal cable 125 is an example of a metal cable for connecting a receiving-side power supply, the metal cable being connectable to the receiving-side power supply when the receiving-side power supply is disposed outside the receiver 12 and being capable of supplying electric power from the receiving-side power supply to the O/E converter 121 and the receiver circuit 122. The metal cable 125 is drawn from the housing of the receiver 12 so as to be connectable to the receiving-side power supply. Accordingly, in a case where the transmitter 11 is connected to the receiver 12 by using a cable, one or more embodiments enable a reduction in the outer diameter of the cable, as is the case for the transmitter 11.

As described above, when the transmitter 11 further includes the metal cable 115, it is possible to use solder to electrically connect an end of the metal cable 115 to a second substrate 110b. This makes it possible to connect the metal cable 115 to the second substrate 110b by using a simpler configuration than when a connector is used. That is, it is possible to reduce manufacturing costs of the transmitter 11. This provides a configuration in which the metal cable 115 is connected to the substrate 110 via solder. Soldered connections have higher reliability than, for example, connections by connectors. The receiver 12 further including the metal cable 125 also yields the same effect.

Although the signal source 111 is an image sensor in one or more embodiments, the present invention is not limited to this. The signal source 111 can be any device that outputs an electrical signal. Examples of a device that is usable as the signal source 111 include a sensor such as an image sensor, a color sensor, a luminance sensor, a wavelength sensor, a temperature sensor, a vibration sensor, or a strain sensor or a processor such as a central processing unit (CPU).

Although the electrical signal ES outputted from the signal source 111 is inputted as is into the E/O converter 112 in one or more embodiments, the present invention is not limited to this. The E/O converter 112 can receive an electrical signal that is obtained by processing, with the use of a signal processing circuit such as a serializer, the electrical signal ES outputted from the signal source 111 (see Variation 4 that will be described later).

In a case where the electrical signal ES outputted from the signal source 111 is inputted as is into the E/O converter 112, it is not necessary to provide the transmitter 11 with a signal processing circuit such as a serializer. This enables a simplification of the configuration of the transmitter 11. Further, it is not necessary, in this case, to provide the receiver 12 with a signal processing circuit such as a deserializer. This enables a simplification of the configuration of the receiver 12. For example, an image signal compliant with the SLVS-EC, which contains a clock in the data column thereof, may be applicable to this aspect. The advantages of the configuration in which a signal processing circuit such as a serializer is used will be described later in Variation 4 of the transmitter.

Although the metal cable 115 that carries electric power to be supplied to the signal source 111 is a metal cable independent of the optical cable 113 in one or more embodiments, the present invention is not limited to this. Specifically, the metal cable 115 that carries electric power to be supplied to the signal source 111 can be a metal cable that, together with the optical cable 113, constitutes a composite cable (see Variations 1 and 2 which will be described later). Alternatively, the transmitter 11 may include, instead of the metal cable 115, an electrical connector for connecting the metal cable 115 (see Variation 3 which will be described later).

(Configuration of Transmitter)

The following description will discuss a configuration of the transmitter 11 with reference to FIG. 2. (a) of FIG. 2 is a side view illustrating the configuration of the transmitter 11. (b) of FIG. 2 is a plan view of a first substrate 110a (which will be described later) included in the transmitter 11. (c) of FIG. 2 is a plan view of a second substrate 110b (which will be described later) included in the transmitter 11.

The transmitter 11 includes the first substrate 110a and the second substrate 110b, in addition to the signal source 111, the E/O converter 112, the optical cable 113, the optical connector 114, and the metal cable 115 that are described earlier. The signal source 111 is provided to the first substrate 110a and the E/O converter 112 is provided to the second substrate 110b. The first substrate 110a to which the signal source 111 is provided and the second substrate 110b to which the E/O converter 112 is provided are stacked.

Particularly in one or more embodiments, the first substrate 110a has one main surface 110a1 to which the signal source 111 is provided, and the first substrate 110a has the other main surface 110a2 to which a substrate-to-substrate connector 110a3 is provided. Further, in one or more embodiments, the second substrate 110b has one main surface 110b1 to which a substrate-to-substrate connector 110b3 that is complementary to the substrate-to-substrate connector 110a3 is provided, and the second substrate 110b has the other main surface 110b2 to which the E/O converter 112 is provided. When the substrate-to-substrate connector 110a3 of the first substrate 110a is electrically and mechanically connected to the substrate-to-substrate connector 110b3 of the second substrate 110b, the signal source 111 of the first substrate 110a is electrically connected to the E/O converter 112 of the second substrate 110b. When the first substrate 110a and the second substrate 110b are stacked in this manner, it is possible to keep small the spatial extent required for the first substrate 110a and the second substrate 110b to be disposed, and thereby increase densities at which the first substrate 110a and the second substrate 110b are packed. This makes it easier to make the transmitter 11 more compact.

In one or more embodiments, the substrate-to-substrate connector 110a3 and the substrate-to-substrate connector 110b3 each include a plurality of terminals. When the substrate-to-substrate connector 110a3 and the substrate-to-substrate connector 110b3 are brought into contact with each other, the electrical signal ES is transmitted from the substrate-to-substrate connector 110a3 to the substrate-to-substrate connector 110b3 via the plurality of terminals. The terminals of the substrate-to-substrate connector 110a3 each have a shape complementary to that of the corresponding one of the terminals of the substrate-to-substrate connector 110b3. Therefore, each of the terminals of the substrate-to-substrate connector 110a3 and the corresponding one of the terminals of the substrate-to-substrate connector 110b3 are fitted to each other while being in surface contact with each other, so that the substrate-to-substrate connector 110a3 and the substrate-to-substrate connector 110b3 are connected together. In this regard, each of the terminals has a shape of, for example, a leaf spring. The plurality of terminals are arranged in one row or in a plurality of rows along a plane substantially orthogonal to each of the main surfaces 110a1, 110a2, 110b1, and 110b2. For example, in a case where either the first substrate 110a or the second substrate 110b is a mezzanine card, examples of the substrate-to-substrate connectors 110a3 and 110b3 that have such a plurality of terminals include a mezzanine connector that is provided on a main surface of each of the first substrate 110a and the second substrate 110b and that connects the first substrate 110a to the second substrate 110b. In this regard, the mezzanine card is a compact circuit board that is attached to a main electronics board so as to overlap and be parallel to the main electronics board, in order to incorporate additional functions into the main electronics board. Examples of such a mezzanine card include an electronics board attachable to the motherboard of a computer and an electronics board attachable to an extension card.

This configuration makes it possible to make spacing between adjacent terminals narrower than a configuration in which employed is a terminal for a press-fit pin header as each of the plurality of terminals of the substrate-to-substrate connectors 110a3 and 110b3. It is therefore possible to make more compact the substrate-to-substrate connectors 110a3 and 110b3. In a case where the terminal for a press-fit pin header is employed, it is necessary to increase the spacing between the adjacent terminals according to spacing between through holes. This makes it difficult to make the substrate-to-substrate connectors 110a3 and 110b3 more compact.

In a case of employing a configuration in which the plurality of terminals are arranged in one row along a plane substantially orthogonal to each of the main surfaces 110a1, 110a2, 110b1, and 110b2, it is possible to save space required for the arrangement of the plurality of terminals via which respective electrical signals ES can be transmitted. Alternatively, in a case of employing a configuration in which the plurality of terminals are arranged in a plurality of rows (for example, two rows), it is possible to both save space and multiply the number of terminals by a factor of the number of rows.

In one or more embodiments, the plurality of terminals have respective side edge surfaces having a smaller area and respective main surfaces having a larger area, and are arranged such that the side edge surfaces, rather than the main surfaces, face each other. When the respective terminals are arranged in this manner, it is possible to reduce the coupling capacitance generated between the adjacent terminals. As described above, the substrate-to-substrate connectors 110a3 and 110b3 makes it possible to make the spacing between the adjacent terminals smaller than a substrate-to-substrate connector that is provided with terminals for a press-fit pin header as the plurality of terminals. Since it is possible to reduce the coupling capacitance generated between the adjacent terminals, it is possible to, even in a case of a smaller spacing between the adjacent terminals, both increase the transmission bands of the respective terminals and reduce crosstalk that could be generated between the adjacent terminals.

In a case where the number of the plurality of terminals is not less than four, it is possible to transmit one or more differential pairs of signals by using, for example, the first, second, third, and fourth terminals respectively as a ground line, a signal line, a signal line, and a ground line. This enables a reduction in noise that could be generated when the electrical signals ES are transmitted between the signal source 111 and the E/O converter 112, to which connections are made via the substrate-to-substrate connector 110a3 and the substrate-to-substrate connector 110b3, respectively.

Although an end of the optical cable 113 is disposed on the main surface 110b2 (the same main surface that the E/O converter 112 is provided to)-side of the second substrate 110b in one or more embodiments, the present invention is not limited to this. For example, in a case where the second substrate 110b is a glass substrate, the end of the optical cable 113 may be disposed on the main surface 110b1 (the main surface opposite to that the E/O converter 112 is provided to)-side of the second substrate 110b. In this case, a configuration may be employed in which the optical signal LS outputted from the E/O converter 112 is passed through the second substrate 110b, then reflected by a turning mirror, and then inputted to the end of the optical cable 113. The turning mirror is disposed so that the optical signal LS outputted from the E/O converter 112 is reflected so as to be optically coupled to the end of the optical cable 113.

(Variation 1 of Transmitter)

The following description will discuss a transmitter 11A, which is Variation 1 of the transmitter 11, with reference to FIG. 3. FIG. 3 is a block diagram of the transmitter 11A in accordance with Variation 1.

In the transmitter 11 illustrated in FIG. 1, a metal cable independent of the optical cable 113 is used as the metal cable 115 that carries electric power to be supplied to the signal source 111. In contrast, in the transmitter 11A illustrated in FIG. 3, a metal cable that, together with the optical cable 113, constitutes a composite cable 116 is used as the metal cable 115 that carries electric power to be supplied to the signal source 111. The transmitter 11A illustrated in FIG. 3 therefore enables supply of electric power to the signal source 111 from a power supply which is apart from the signal source 111 and which is electrically connected to the receiver 12. Accordingly, it is possible to use a single composite cable 116 to achieve not only inter-device communications but also supply of electric power to the signal source 111 and/or the E/O converter 112. This enables a simplification of the configuration of the transmitter 11. Although the metal cable 115 is electrically connected to the E/O converter 112 in one or more embodiments, the metal cable 115 may not be electrically connected to the E/O converter 112. However, the metal cable 115 may be electrically connected to the E/O converter 112. This configuration eliminates the need to so provide a metal cable carrying electric power to the signal source 111 and the E/O converter 112 that the metal cable runs parallel to the optical cable 113. That is, it is not necessary to use, as a cable to be connected to the E/O converter 112, a composite cable including an optical cable and a metal cable. The above configuration therefore makes it possible to make simpler the structure of the cable to be connected to the E/O converter 112 than a configuration in which a composite cable is used as the cable to be connected to the E/O converter 112. This can enable a cost reduction. In addition, it can be possible to increase a transmission distance in the communication system 1. It can also be possible to make the cable more compact and/or lighter. In a case where the cable is provided in the form of an optical cable, it can be possible to reduce or prevent a drop in voltage.

(Variation 2 of Transmitter)

The following description will discuss a transmitter 11B, which is Variation 2 of the transmitter 11, with reference to FIG. 4. FIG. 4 is a block diagram of the transmitter 11B in accordance with Variation 2.

In the transmitter 11 illustrated in FIG. 1, a metal cable independent of the optical cable 113 is used as the metal cable 115 that carries electric power to be supplied to the signal source 111. In contrast, in the transmitter 11B illustrated in FIG. 4, a metal cable that, together with the optical cable 113, constitutes the composite cable 116 is used as the metal cable 115 that carries electric power to be supplied to the signal source 111. Accordingly, using the transmitter 11B illustrated in FIG. 4 enables supply of electric power to the signal source 111 from a power supply which is apart from the signal source 111 and which is electrically connected to the receiver 12.

Further, the transmitter 11B illustrated in FIG. 4 includes a control section 117. In addition, in the transmitter 11B illustrated in FIG. 4, a metal cable that, together with the optical cable 113, constitutes the composite cable 116 and the metal cable 115 is used as a metal cable 118 that carries a control signal to be supplied to the control section 117. The transmitter 11B illustrated in FIG. 4 therefore enables supply of a control signal to the control section 117 from a control signal source disposed near or in the receiver 12. Although the metal cable 115 and the E/O converter 112 are electrically connected to each other in one or more embodiments, the metal cable 115 and the E/O converter 112 may not be electrically connected to each other. However, the metal cable 115 and the E/O converter 112 may be electrically connected to each other. This configuration eliminates the need to so provide a metal cable carrying electric power to the signal source 111 and the E/O converter 112 that the metal cable runs parallel to the optical cable 113. That is, it is not necessary to use, as a cable to be connected to the E/O converter 112, a composite cable including an optical cable and a metal cable. The above configuration therefore makes it possible to make simpler the structure of the cable to be connected to the E/O converter 112 than a configuration in which a composite cable is used as the cable to be connected to the E/O converter 112. This can enable a cost reduction. In addition, it can be possible to increase a transmission distance in the communication system 1. It can also be possible to make the cable more compact and/or lighter. In a case where the cable is provided in the form of an optical cable, it can be possible to reduce or prevent a drop in voltage.

(Variation 3 of Transmitter)

The following description will discuss a transmitter 11C, which is Variation 3 of the transmitter 11, with reference to FIG. 5. FIG. 5 is a block diagram of the transmitter 11C in accordance with Variation 3.

In the transmitter 11 illustrated in FIG. 1, provided is a metal cable 115 that carries electric power to be supplied to the signal source 111. In contrast, in the transmitter 11C illustrated in FIG. 5, provided is an electrical connector 119 for connecting the metal cable 115 that carries electric power to be supplied to the signal source 111. The transmitter 11C illustrated in FIG. 5 therefore enables easy attachment and detachment of the metal cable 115 that carries electric power to be supplied to the signal source 111. In one or more embodiments, the metal cable 115 may be electrically connected only to the signal source 111, may be electrically connected to the signal source 111 and to the E/O converter 112, or may be electrically connected only to the E/O converter 112. However, the metal cable 115 may be electrically connected to the signal source 111 and to the E/O converter 112. This configuration eliminates the need to provide, via the optical connector 114, another cable for supplying electric power to the signal source 111 or the E/O converter 112, in addition to the metal cable 115. This makes it possible to transmit electric power to the signal source 111 and the E/O converter 112 by using a single cable. The above configuration therefore makes it possible to make simpler the structure of the cable provided via the optical connector 114 than a configuration in which the metal cable 115 is electrically connected only to the signal source 111 or only to the E/O converter 112. This can enable a cost reduction. In addition, it can be possible to increase a transmission distance in the communication system 1. It can also be possible to make the cable more compact and/or lighter. In a case where the cable is provided as an optical cable, it can be possible to reduce or prevent a drop in voltage.

(Variation 4 of Transmitter)

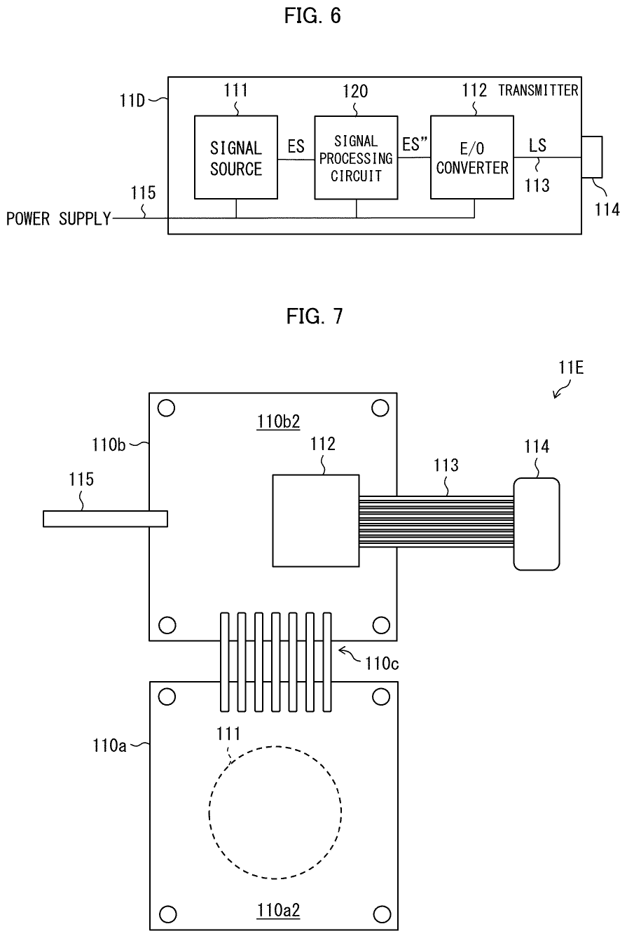

The following description will discuss a transmitter 11D, which is Variation 4 of the transmitter 11, with reference to FIG. 6. FIG. 6 is a block diagram of the transmitter 11D in accordance with Variation 4.

In the transmitter 11 illustrated in FIG. 1, the electrical signal ES outputted from the signal source 111 is inputted as is into the E/O converter 112. In contrast, in the transmitter 11D illustrated in FIG. 6, the E/O converter 112 receives an electrical signal ES″ that is obtained by processing, with the use of a signal processing circuit 120, the electrical signal ES outputted from the signal source 111. For example, in a case where the signal source 111 is an image sensor, a serializer is used as the signal processing circuit 120 to serialize image signals outputted as the electrical signal ES in parallel from the signal source 111 and a clock signal. This makes it possible to transmit the image signals outputted as the electrical signal ES in parallel from the signal source 111 and the clock signal, over a long distance and at a high rate without generating a skew (a variation in delay time). In addition, the above serialization enables a reduction in the number of cores that constitutes the optical cable 113. The above serialization also makes it possible to reduce the number of the E/O converters 112 to, for example, one. In one or more embodiments, the metal cable 115 may be electrically connected only to the signal source 111, may be electrically connected to the signal source 111 and to the signal processing circuit 120, may be electrically connected to the signal source 111 and to the E/O converter 112, or may be electrically connected to the signal source 111, to the signal processing circuit 120, and to the E/O converter 112. However, the metal cable 115 may be electrically connected to the signal source 111, to the E/O converter 112, and to the signal processing circuit 120. This configuration eliminates the need to provide, via the optical connector 114, another cable for supplying electric power to at least any one of the signal source 111, the E/O converter 112, and the signal processing circuit 120, in addition to the metal cable 115. Accordingly, it is possible to transmit, by using a single cable, electric power to the signal source 111, the E/O converter 112, and the signal processing circuit 120. The above configuration therefore makes it possible to make simpler the structure of the cable that is provided via the optical connector 114 than a configuration in which the metal cable 115 and the signal source 111, the E/O converter 112, and the signal processing circuit 120 are not electrically connected to each other. This enables a cost reduction. In addition, it can be possible to increase a transmission distance in the communication system 1. It can also be possible to make the cable more compact and/or lighter. In a case where the cable is provided in the form of an optical cable, it can be possible to reduce or prevent a drop in voltage.

(Variation 5 of Transmitter)

The following description will discuss a transmitter 11E, which is Variation 5 of the transmitter 11, with reference to FIG. 7. FIG. 7 is a plan view illustrating a configuration of the transmitter 11E in accordance with Variation 5.

In the transmitter 11 illustrated in FIG. 2, the first substrate 110a to which the signal source 111 is provided and the second substrate 110b to which the E/O converter 112 is provided are disposed so as to be apart from each other. Further, in the transmitter 11 illustrated in FIG. 2, the first substrate 110a to which the signal source 111 is provided and the second substrate 110b to which the E/O converter 112 is provided are connected to each other by means of the substrate-to-substrate connectors 110a3 and 110b3, each of which is an example of an electrical connector. In contrast, in the transmitter 11E illustrated in FIG. 7, the first substrate 110a to which the signal source 111 is provided and the second substrate 110b to which the E/O converter 112 is provided are disposed side by side and so as to be apart from each other. Further, in the transmitter 11E illustrated in FIG. 7, the first substrate 110a to which the signal source 111 is provided and the second substrate 110b to which the E/O converter 112 is provided are connected to each other by means of bonding wires 110c. When the first substrate 110a and the second substrate 110b are disposed side by side in this manner, it is possible to keep small the height of space required for the first substrate 110a and the second substrate 110b to be disposed. This makes it easier to make the transmitter 11 more compact in thickness.

In Variation 5, the signal source 111 is provided to the one main surface 110a1 of the first substrate 110a, and the E/O converter 112 is provided to the other main surface 110b2 of the second substrate 110b. However, in an aspect of the present invention, a main surface to which the signal source 111 is to be provided can be the main surface 110a1 or the main surface 110a2, and a main surface to which the E/O converter 112 is to be provided can be the main surface 110b1 or the main surface 110b2.

(Variation 6 of Transmitter)

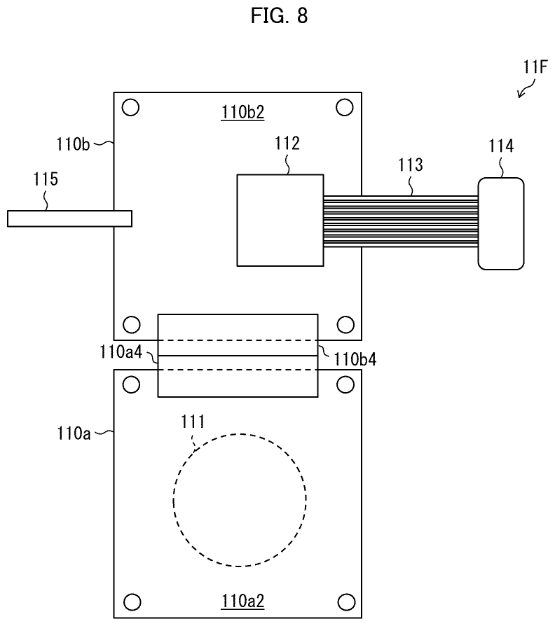

The following description will discuss a transmitter 11F, which is Variation 6 of the transmitter 11, with reference to FIG. 8. FIG. 8 is a plan view illustrating a configuration of the transmitter 11F.

In the transmitter 11E illustrated in FIG. 7, the first substrate 110a to which the signal source 111 is provided and the second substrate 110b to which the E/O converter 112 is provided are connected to each other by means of the bonding wires 110c. In contrast, in the transmitter 11F illustrated in FIG. 8, the main surface 110a2, which is the other main surface of the first substrate 110a, is provided with a substrate-to-substrate connector 110a4 which is an example of an electrical connector, and the main surface 110b2, which is the other main surface of the second substrate 110b, is provided with a substrate-to-substrate connector 110b4 which is an example of an electrical connector. In Variation 6, each of the substrate-to-substrate connectors 110a4 and 110b4 is an angle connector. In this context, the first substrate 110a and the second substrate 110b are electrically connected to each other by means of the substrate-to-substrate connectors 110a4 and 110b4. The substrate-to-substrate connectors 110a4 and 110b4 enable durability enhancement of the first substrate 110a and the second substrate 110b connected to each other, in comparison with the bonding wires 110c.

In Variation 6, the signal source 111 is provided to the one main surface 110a1 of the first substrate 110a, and the E/O converter 112 is provided to the other main surface 110b2 of the second substrate 110b. However, in an aspect of the present invention, a main surface to which the signal source 111 to be provided can be the main surface 110a1 or the main surface 110a2, and a main surface to which the E/O converter 112 is to be provided can be the main surface 110b1 or the main surface 110b2.

(Variation 7 of Transmitter)

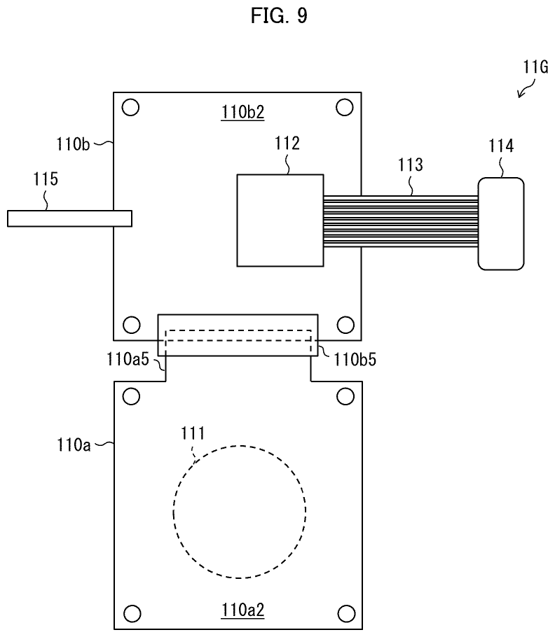

The following description will discuss a transmitter 11G, which is Variation 7 of the transmitter 11, with reference to FIG. 9. FIG. 9 is a plan view illustrating a configuration of the transmitter 11G in accordance with Variation 7.

In the transmitter 11E illustrated in FIG. 7, the first substrate 110a to which the signal source 111 is provided and the second substrate 110b to which the E/O converter 112 is provided are connected to each other by means of the bonding wires 110c. In contrast, in the transmitter 11G illustrated in FIG. 9, a substrate-to-substrate connector 110a5, which is an example of an electrical connector, is provided along one of the four sides, in a plan view, of the first substrate 110a, and a substrate-to-substrate connector 110b5, which is an example of an electrical connector, is provided on the main surface 110b2, which is the other main surface of the second substrate 110b. In Variation 7, the substrate-to-substrate connector 110a5 is an edge connector and the substrate-to-substrate connector 110b5 is an angle connector. In this context, the first substrate 110a and the second substrate 110b are electrically connected to each other by inserting the substrate-to-substrate connector 110a5 in the substrate-to-substrate connector 110b5. The substrate-to-substrate connectors 110a5 and 110b5 enable durability enhancement of the first substrate 110a and the second substrate 110b connected to each other, in comparison with the bonding wires 110c.

In Variation 7, the signal source 111 is provided to the one main surface 110a1 of the first substrate 110a, and the E/O converter 112 is provided to the other main surface 110b2 of the second substrate 110b. However, in an aspect of the present invention, a main surface to which the signal source 111 is to be provided can be the main surface 110a1 or the main surface 110a2, and a main surface to which the E/O converter 112 is to be provided can be the main surface 110b1 or the main surface 110b2.

[Main Points]

A transmitter in accordance with Aspect 1 of the present invention includes a configuration in which the transmitter includes a first substrate; a signal source provided to the first substrate; a second substrate different from the first substrate; an E/O converter provided to the second substrate and configured to convert, into an optical signal, an electrical signal outputted from the signal source; an optical cable that carries the optical signal outputted from the E/O converter; and an optical connector provided at an end of the optical cable, the electrical signal outputted from the signal source being inputted as is into the E/O converter.

A transmitter in accordance with Aspect 2 of the present invention includes, in addition to the configuration of the transmitter in accordance with Aspect 1, a configuration in which the transmitter further including a housing that houses at least the signal source and the E/O converter, wherein the optical connector is provided at an end part of the housing.

A transmitter in accordance with Aspect 3 of the present invention includes, in addition to the configuration of the transmitter in accordance with Aspect 1 or 2, a configuration in which the transmitter further includes a metal cable independent of the optical cable, wherein the metal cable is for connecting a transmitting-side power supply, the metal cable being connectable to the transmitting-side power supply when the transmitting-side power supply is disposed outside the transmitter and being capable of supplying electric power from the transmitting-side power supply to the signal source and the E/O converter.

A transmitter in accordance with Aspect 4 of the present invention includes, in addition to the configuration of the transmitter in accordance with Aspect 1 or 2, a configuration in which the transmitter further includes a metal cable that carries electric power to be supplied to the signal source and that, together with the optical cable, constitutes a composite cable.

A transmitter in accordance with Aspect 5 of the present invention includes, in addition to the configuration of the transmitter in accordance with any one of Aspects 1 to 4, a configuration in which the transmitter further includes an electrical connector for connecting a metal cable that carries electric power to be supplied to the signal source.

A transmitter in accordance with Aspect 6 of the present invention include, in addition to the configuration of the transmitter in accordance with any one of Aspects 1 to 5, a configuration in which the first substrate and the second substrate are stacked and connected to each other by respective substrate-to-substrate connectors provided to the first substrate and the second substrate; and the respective substrate-to-substrate connectors each include a plurality of terminals via which the electrical signal outputted from the signal source is transmitted to the E/O converter, the plurality of terminals provided to the first substrate each have a shape complementary to a shape of a corresponding one of the plurality of terminals provided to the second substrate, the plurality of terminals provided to the first substrate are arranged in one row or in a plurality of rows along a plane substantially orthogonal to main surfaces of the first substrate, and the plurality of terminals provided to the second substrate are arranged in one row or in a plurality of rows along a plane substantially orthogonal to main surfaces of the second substrate.

A receiver configured to receive an optical signal transmitted from a transmitter in accordance with any one of Aspects 1 to 6 in accordance with Aspect 7 of the present invention includes a configuration in which the receiver includes an O/E converter configured to convert the optical signal into an electrical signal; and a receiver circuit configured to process, as an electrical signal outputted from the signal source, the electrical signal outputted from the O/E converter.

A communication system in accordance with Aspect 8 of the present invention includes: a configuration in which the communication system includes a transmitter in accordance with any one of Aspects 1 to 6; and a receiver in accordance with Aspect 7.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Communication system

11 Transmitter

110a First substrate

110a3 Substrate-to-substrate connector

110b Second substrate

110b3 Substrate-to-substrate connector

111 Signal source

112 E/O converter

113 Optical cable

114 Optical connector

115 Metal cable (for electric power transmission)

116 Composite cable

117 Control section

118 Metal cable (for control signal transmission)

119 Electrical connector

120 Signal processing circuit

12 Receiver

121 O/E converter

122 Receiver circuit

123 Optical cable

124 Optical connector

125 Metal cable (for electric power transmission)

1. A transmitter comprising:
a first substrate;
a signal source disposed on the first substrate;
a second substrate different from the first substrate;
an electrical-to-optical (E/O) converter disposed on the second substrate and that converts an electrical signal outputted from the signal source into an optical signal;
an optical cable that carries the optical signal; and
an optical connector disposed at an end of the optical cable, wherein
the electrical signal is inputted into the E/O converter.

2. The transmitter according to claim 1, further comprising:
a housing that houses the signal source and the E/O converter, wherein
the optical connector is disposed at an end part of the housing.

3. The transmitter according to claim 1, further comprising:
a metal cable independent of the optical cable, wherein
the metal cable is:
for connecting a transmitting-side power supply,
connectable to the transmitting-side power supply when the transmitting-side power supply is disposed outside the transmitter and
capable of supplying electric power from the transmitting-side power supply to the signal source and the E/O converter.

4. The transmitter according to claim 1, further comprising:
a metal cable that carries electric power to be supplied to the signal source, wherein
the metal cable and the optical cable constitute a composite cable.

5. The transmitter according to claim 1, further comprising an electrical connector for connecting a metal cable that carries electric power to be supplied to the signal source.

6. The transmitter according to claim 1, wherein
the first substrate is stacked on and connected to the second substrate by substrate-to-substrate connectors that are disposed to each of the first substrate and the second substrate,
the substrate-to-substrate connectors each comprise terminals via which the electrical signal is transmitted to the E/O converter,
the of terminals of the first substrate each have a shape complementary to a shape of a corresponding one of the terminals of the second substrate,
the terminals of the first substrate are disposed in one or more rows along a plane substantially orthogonal to main surfaces of the first substrate, and
the terminals of the second substrate are disposed in one or more rows along a plane substantially orthogonal to main surfaces of the second substrate.

7. A receiver that receives an optical signal transmitted from the transmitter according to claim 1, the receiver comprising:
an optical-to-electrical (O/E) converter that converts the optical signal into an electrical signal; and
a receiver circuit that processes, as an electrical signal outputted from the signal source, the electrical signal outputted from the O/E converter.

8. A communication system comprising:
a transmitter according to claim 1; and
a receiver that receives an optical signal transmitted from the transmitter, wherein
the receiver comprises:
an optical-to-electrical (O/E) converter that converts the optical signal into an electrical signal; and
a receiver circuit that processes, as an electrical signal outputted from the signal source, the electrical signal outputted from the O/E converter.
